(19) United States
(12) Patent Application Publication
(10) Pub. No.: US 2006/0200812 A1
(43) Pub. Date: Sep. 7, 2006

(54) Software update system, software providing device, software processing device, and software update method

(75) Inventors: Masao Mizutani, Tokyo (JP); Junji Kato, Tokyo (JP); Yoshihiro Nakada, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/560,442

(22) PCT Filed: Jun. 18, 2004
(86) PCT No.: PCT/JP04/08947

§ 371 Date: Dec. 13, 2005

(30) Foreign Application Priority Data
Jun. 20, 2003 (JP) 2003-176662

(51) Int. Cl. G06F 9/44

(52) U.S. Cl. 717/168

(57) ABSTRACT

Software-creating portion 11 creates update data and version-up data and supplies them to a receiver 20 through a delivery portion 13 or a server 15. The update data includes pieces of revision information of the version-up data after a period of time of each of their applications. Revision-information-processing portion 31 supplies revision information relative to software in a memory 34 to rewriting portion 33 and maintains remaining revision information. Data-revising portion 32 extracts revision information relative to the version-up data that is supplied through interfaces 25 and 26 from revision information maintained in the revision-information-processing portion 31, revises it to the latest one with it reflecting the version-up data, and then supplies it to the rewriting portion 33. The rewriting portion 33 rewrites the software in the memory 34 with the revision information and the version-up data thus supplied. This allows the software to be rewritten in which its latest condition is always realized.

### TECHNICAL FIELD

The present invention relates to a software revision system, a software distribution apparatus, software-processing apparatus, and a software revision method. More specifically, it provides multiple items of software revision data, each item of the software revision data including revision information relative to other software revision data after a period of time of its application. Further, if software is rewritten using software revision data, revision information is maintained when the software revision data includes the revision information or software including the revision information is rewritten when the revision information relative to the software revision data is maintained.

### BACKGROUND ART

In equipment using software, the software has been able to be revised not only by operating the equipment individually, but also by itself. Following will describe this using a digital broadcast. Transmitter for digital broadcast transmits not only image data and audio data for a program but also download data etc. with them being packetized and multiplied, as well as receiver for digital broadcast extracts a packet of the download data from the multiplied signal and revises its software using this downloaded data.

It has been disclosed in a patent publication (Japanese Patent Application Publication No. H06-309261) that a server transmits a command for getting start of installation to clients via a network and a client, which receives the command for getting start of installation, performs installation process of the software that is transmitted from the server to install the software automatically.

In the meantime, on the revision of software, update and/or version-up thereof have been made. The update relates to a revision of software by providing update information for a plurality of files constituting the software, the update information being update data that is composed of data for file (s) required to be changed or added and data for erasing unnecessary file(s), and rewriting the software by using this update data. The version-up relates to a revision of software by providing new software including additional functions, alteration in functions and the like as version-up data and rewriting the software by using this version-up data.

FIGS. 1A through 1C illustrate a revised order of software and FIG. 1A illustrates first distributed software SF1. FIGS. 1B and 1C illustrate items of software SF2 and SF3, respectively, both of which are distributed as version-up data thereafter.

The software SF1 is rewritten every update by using the update data, so that its version number can alter according to an order such as Ver1.0 to Ver1.4 through Ver1.1, Ver1.2 and Ver1.3. Similarly, the software SF2 is rewritten every update, so that its version number can alter according to an order such as Ver2.0 to Ver2.3 through Ver2.1 and Ver2.2; and the software SF3 is rewritten every update, so that its version number can alter according to an order such as Ver3.0 to Ver3.1.

If software that is presently being used is revised as version-up to produce software, which is distributed after the presently used software is distributed, the latest software of respective versions can be used. For example, if after starting distribution of the software SF2, the software SF1 is revised from its version Ver1.1 to version Ver2.0 of the software SF2 as shown by a solid line therein or if after starting distribution of the softfware SF3, the software SF1 is revised from its version Ver1.1 to version Ver3.0 of the software SF3 as shown by a solid line therein, the latest software of respective versions can be used.

If, however, the presently used software is revised as version-up to any software, which has been distributed before the presently used software is distributed, the latest software can be not used. For example, if given software SF2 is one of its version Ver2.0 so that the software SF1 of its version Ver1.4 can be revised to the software SF2 of its version Ver2.0, which has been distributed before the software SF1 of version Ver1.4, as shown by broken lines therein, such the software can be rewritten without reflecting any contents of the update on the software SF2. Alternatively, if given software SF3 is one of its version Ver3.0 so that the software SF1 of its version Ver1.4 can be revised to the software SF3 of its version Ver3.0, which has been distributed before the software SF1 of version Ver1.4, as shown by broken lines therein, such the software can be rewritten without reflecting any contents of the update on the software SF3. When version-up to the software SF2 is thus made, no contents of the updates up to the version Ver2.3 can be reflected as well as when version-up to the software SF3 is made, no contents of the update up to the version Ver3.1 can be reflected, so that a user cannot use the latest software thereof.

Further, in order to allow software of each version to be used with their latest states, a user is requested to execute version-up operations according to a previously set order therefor or to update the software after these version-up operations. This causes these operations to be complex.

### DISCLOSURE OF THE INVENTION

A software revision system relative to the invention comprises software-distributing means for distributing multiple items of software revision data, and software-processing means for maintaining software and performing processing based on the maintained software as well as for rewriting the maintained software by using the software revision data that is distributed with the software-distributing means, wherein the software-distributing means distributes the software revision data including revision information relative to other software revision data after a period of time of its application, and wherein the software-processing means maintains the revision information included in the software revision data when rewriting the software by using the software revision data, and rewrites the software including the revision information if the revision information on the software revision data is maintained.

A software distribution apparatus relative to the invention comprises software-creating means for creating multiple items of software revision data with each item of the software revision data including revision information relative to other software revision data after a period of time of its application, and software-disseminating means for disseminating the software created in the software-creating means.

A software-processing apparatus relative to the invention is a software-processing apparatus operating by using software that is rewritably stored, which comprises revision-information-processing means for, when software revision data includes revision information relative to other software revision data after a period of time of its application, separating and maintaining the revision information, rewriting means for rewriting the stored software by using the software revision data, and data-revising means for supplying to the rewriting means the software revision data including the revision information thereof when maintaining the revision information relative to the software revision data in the revision-information-processing means.

A software revision method relative to the invention comprises a software-distributing step of distributing multiple items of software revision data with each item of software revision data including revision information relative to other software revision data after a period of time of its application, and a software-processing step of, when rewriting software by using the software revision data, maintaining the revision information if the revision information is included in the software revision data, and rewriting the software including the revision information if the revision information on the software revision data is maintained.

According to the invention, each of the distributed multiple items of software revision data includes revision information relative to other software revision data after a period of time of each of its application. For example, update data indicating a part to be updated of the software and version-up data that is new software, which is updated, are distributed as software revision data as well as the revision information of items of the version-up data after a period of time of its application is included in the update data. When performing processing based on the maintained software as well as rewriting the maintained software by using the distributed software revision data, it maintains the revision information included in the software revision data and rewrites the software including the revision information if the revision information on the software revision data to be used for rewriting is maintained. For example, if rewriting the software by using the update data, the revision information included in the update data is maintained and when rewriting the software by using the version-up data, if revision information on the version-up data is maintained, the software including this revision information is rewritten.

### BRIEF DESCRIPTION OF THE DRAWINGS

FIGS. 1A through 1C are diagrams each illustrating a revised order of software;

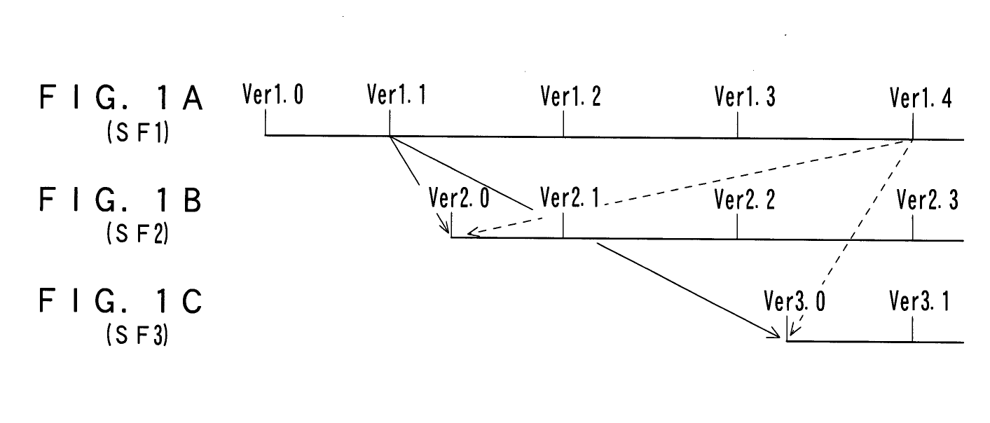

FIG. 2 is a diagram showing an entire configuration of a software revision system;

FIGS. 3A through 3D are diagrams each illustrating creation of update data;

FIG. 4 is a flowchart showing update operations;

FIG. 5 is a flowchart showing version-up operations; and

FIGS. 6A through 6C are diagrams each illustrating an example of the version-up operations.

### BEST MODE FOR CARRYING OUT THE INVENTION

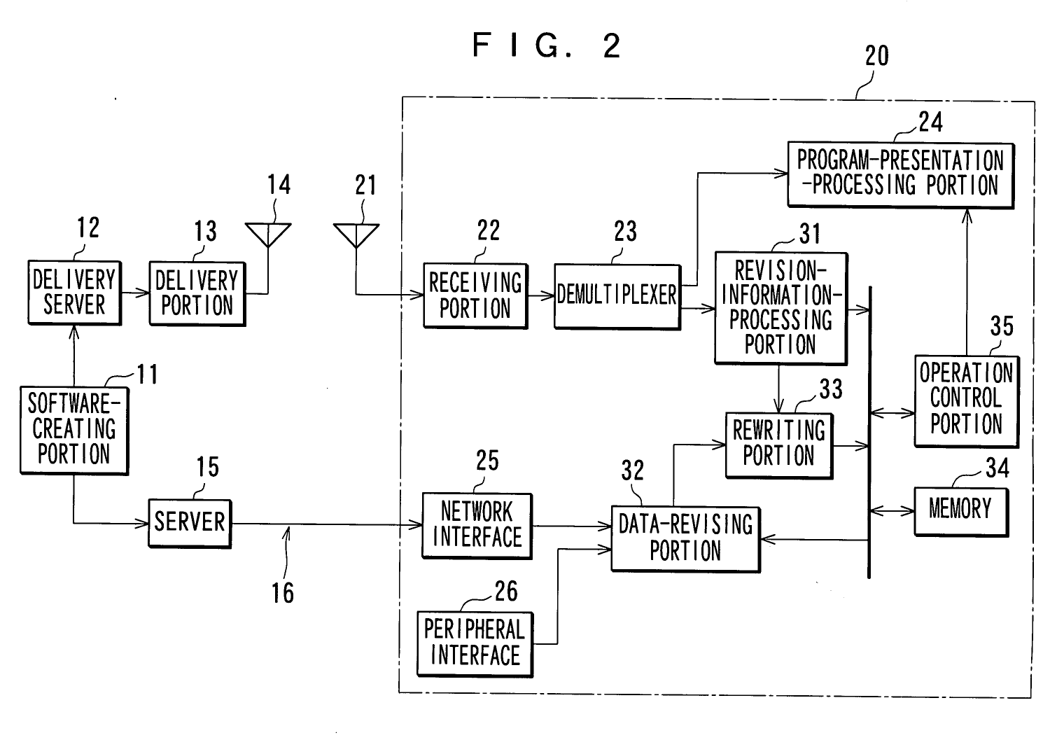

The following will describe an embodiment of the invention with reference to the drawings. FIG. 2 shows a configuration of a software revision system, for example, a software revision system that revises software in a receiver, for example, for receiving a broadcast signal and presenting a broadcast program.

Software-creating portion 11 creates multiple items of software revision data with each item of software revision data including piece(s) of revision information relative to other software revision data after a period of each of their applications. For example, version-up data in which functions are added and/or changed to first distributed software so that its new software is produced is created as the software revision data. Further, update data composed of pieces of revision information relative to a plurality of files constituting the first distributed software or the new software, namely, the data for files required to be changed or added and the data for erasing unnecessary file(s), is created as the software revision data.

In digital broadcast, however, image data and audio data for a program as well as data for an electronic program guide and download data are, respectively, packetized, thereby multiplying the packetized data and broadcasting it. A packet of the download data is inserted between the packets of the image data and the audio data without breaking any image and audio of the program, which causes limitation on an amount of data thereof. Thus, a delivery server 12 and a delivery portion 13, which will be described later, are used as software-disseminating means and update data is supplied to the delivery server 12 so that any faults can be automatically dissolved in a receiver 20.

The delivery server 12 accumulates coded data of image and audio of the programs, data for the electronic program guides, and update data supplied from the software-creating portion 11. It also reads out the accumulated data based on program schedule and supplies it to a delivery portion 13.

The delivery portion 13 packetizes the image data and the audio data for the program, the electronic program guide, and the download data, respectively, which are supplied from the delivery server 12 and then, multiplies them to produce multiplexed signals. Further, it modulates the multiplexed signals to which error-correction code is added and broadcasts them as broadcast signals through a transmitting antenna 14.

In the meantime, in version-up of software, new software in which functions etc. are added and/or changed is used and thus, its amount of data is made larger than that of update data. This causes a period of time required for download to become longer if the version-up data is broadcast utilizing the broadcast signals. A user of the receiver 20 may desire to add or change no function even when function is added or changed in the version-up of software, and thus, it is preferable to execute the version-up thereof according to the user's desire. Therefore, for example, a server 15 is used as the software-disseminating means and the version-up data from the software-creating portion 11 is supplied and maintained to and in the server 15. When the version-up data is requested to this server 15 from the user via a network, the requested version-up data is supplied to the receiver 20 of the user. It may be preferable that recording medium such as optical disk or magnetic disk, which records the version-up data or storage medium such as memory card, which stores the version-up data, is distributed to persons who want to get the version-up and the version-up data is read out of the recording medium or the storage medium to rewrite the software.

A signal received at an antenna 21 of the receiver 20 is supplied to a receiving portion 22. The receiving portion 22 selects target carrier wave from the received signal. It also detects and demodulates the selected carrier wave to produce multiplexed signals, which are supplied to a demultiplexer 23.

The demultiplexer 23 extracts packets for image data and audio data of a desired program from the multiplexed signals and supplies it to a program-presentation-processing portion 24. It also extracts packets for the electronic program guide from the multiplexed signals and supplies the packets to the program-presentation-processing portion 24. It further extracts packets for the update data from the multiplexed signals and supplies the packets to the revision-information-processing portion 31.

The program-presentation-processing portion 24 demodulates the packets for the image data and the audio data to produce an image signal and an audio signal. It then drives display device based on the produced image signal to display image of the program. It further drives a speaker or the like based on the audio signal to output audio of the program. It additionally maintains the data of the electronic program guide and presents the electronic program guide according to the user's request on the basis of the maintained data.

The revision-information-processing portion 31 separates from the update data information of a revision portion of the software that is rewritably stored in the memory 34, and supplies it to a rewriting portion 33 as rewriting data. It also separates revision information of software having a version different from that of the software stored in the memory 34, and maintains it. It is to be noted that no memory is necessary separately for maintaining the revision information if the memory 34 could be used when maintaining the revision information.

A network interface 25 is one that is used for connecting the receiver 20 with the server 15 via a network 16. Herein, the version-up data supplied from the server 15 is supplied to a data-revising portion 32.

A peripheral interface 26 is one that is used for connecting the receiver 20 with any outside apparatus for reading the version-up data out of the recording medium or the storage medium. The version-up data read out of the outside apparatus is supplied to the data-revising portion 32.

The data-revising portion 32 extracts revision information for the supplied version-up data from the revision information that is separated by the revision-information-processing portion 31 and maintained therein, and determines whether contents of this revision information is included in the version-up data. If a period of time of application of this version-up data is older than that of the revision information, the version-up data is revised to the latest one using the revision information. This latest revised version-up data is then supplied to the rewriting portion 33.

The rewriting portion 33 rewrites the software stored in the memory 34 by using rewriting data that is supplied from the revision-information-processing portion 31. It also rewrites the software stored in the memory 34 by using the version-up data that is supplied from the data-revising portion 32.

An operation control portion 35 reads out the software stored in the memory 34 to perform it, thereby allowing operations of each part of the receiver 20 to be controlled. It also controls operations on update or version-up execution.

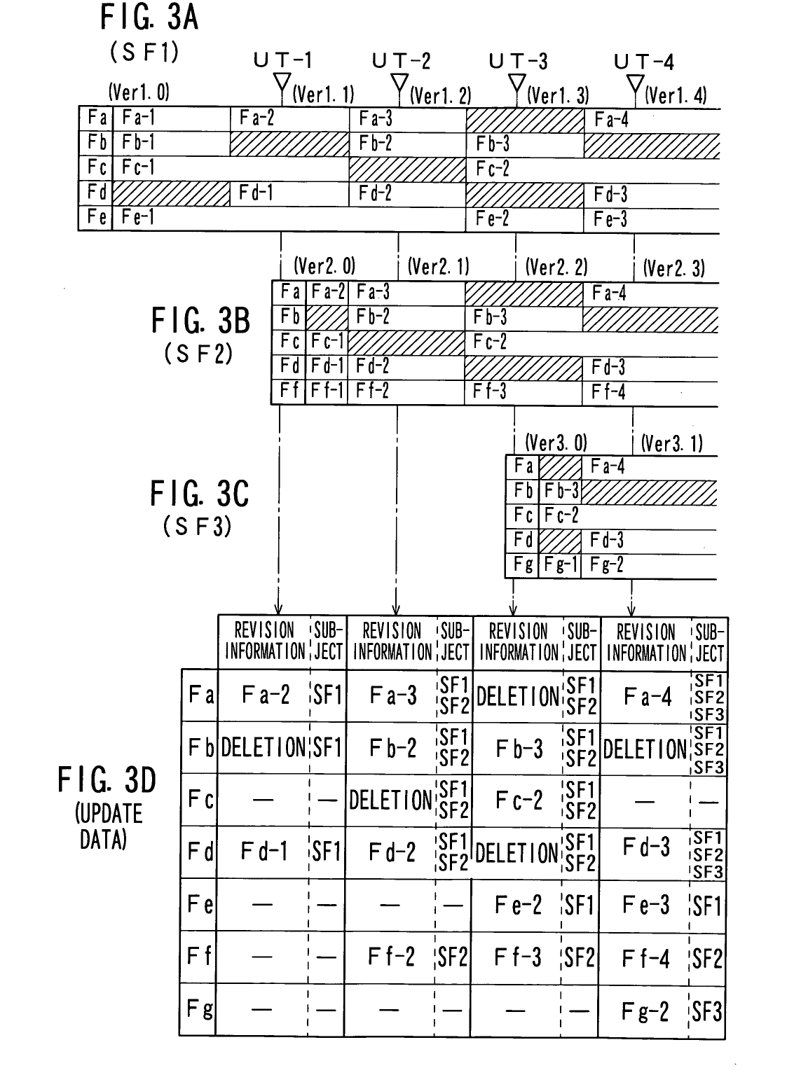

The following will describe revision processing of software. FIGS. 3A through 3D show operations for creation of the update data and the version-up data.

When software SF1 of version Ver1.0 as shown in FIG. 3A is first stored in the memory 34 of the receiver 20, a revision is executed to the software SF1 of version Ver1.0 and functions or the like is added thereto so that update data or version-up data is produced.

The software SF1 of version Ver1.0 is revised to change file Fa from Fa-1 to Fa-2 , delete file Fb, and add file Fd-1 as file Fd. When such the revision is executed as update UT-1, the revision information includes data of the files Fa-2, and Fd-1, and data for deletion of the file Fb. Subject information indicating that a subject of the revision information is software SF1 is also produced, and then the revision information and the subject information are linked to each other to produce update data shown in FIG. 3D. It is to be noted that the software SF1 in which the update UT-1 is executed is called as version Ver1.1.

Further, when the version-up is executed on the software SF1 to produce software SF2 shown in FIG. 3B by deleting functions that are available by file Fe and adding thereto file Ff by which new functions are available, the software SF2 reflecting revision contents of the update UT-1 is distributed as version-up data. This distributed software SF2 is called as version Ver2.0.

A revision is executed after a period of time of application of the software SF2 when it starts to distribute the software SF2, so that, for example, the file Fa is changed from Fa-2 to Fa-3, the file Fd is changed from Fd-1 to Fd-2, the file Ff is changed from Ff-1 to Ff-2, file Fb-2 is added as the file Fb, and the file Fc is deleted. When such the revision is executed as update UT-2, the revision information includes data of the files Fa-3, Fb-2, Fd-2, and Ff-2, and data for deletion of the file Fc. Subject information indicating that subjects of the data of files Fa-3, Fb-2, and Fd-2 and the data for deletion of the file Fc are items of software SF1 and SF2 and a subject of the data of file Ff-2 is software SF2 is also produced, and then the revision information and the subject information are linked to each other to produce the update data. It is to be noted that the software SF1 in which the update UT-2 is executed is called as version Ver1.2 and the software SF2 when doing so is called as version Ver2.1.

Similarly, when, as shown in FIGS. 3A and 3B, respectively, a revision is executed on the software SF1 of version Ver1.2 and a revision is executed on the software SF2 of version Ver2.1 and such the revisions are executed as update UT-3, the revision information of the update data includes data of the files Fb-3, Fc-2, Fe-2, and Ff-3, and data for deletion of the files Fa and Fd. Subject information thereof indicates that subjects of the data of files Fb-3 and Fc-2 and the data for deletion of the files Fa and Fd are items of the software SF1 and SF2; a subject of the data of file Fe-2 is the software SF1; and a subject of the data of file Ff-3 is the software SF2. It is to be noted that the software SF1 in which the update UT-3 is executed is called as version Ver1.3 and the software SF2 when doing so is called as version Ver2.2.

When the version-up is executed on the software SF2 to produce software SF3 shown in FIG. 3C by deleting functions that is available by file Ff from the software SF2 and adding thereto file Fg by which new functions are available, the software SF3 reflecting revision contents of the update UT-3 is distributed as version-up data. This distributed software SF3 is called as version Ver3.0.

Further, when, as shown in FIGS. 3A through 3C, respectively, a revision is performed on the software SF1 of version Ver1.3, a revision is performed on the software SF2 of version Ver2.2, and a revision is performed on the software SF3 of version Ver3.0, and update UT-4 is executed on these revision contents, the revision information of update data includes data of the files Fa-4, Fd-3, Fe-3, Ff-4, and Fg-2, and data for deletion of the file Fb. Subject information indicates that subjects of the data of files Fa-4 and Fd-3 and the data for deletion of the file Fb are items of software SF1, SF2 and SF3; a subject of the data of file Fe-3 is software SF1; a subject of the data of file Ff-4 is software SF2; and a subject of the data of file Fg-2 is software SF3. It is to be noted that the software SF1 in which the update UT-3 is executed is called as version Ver1.3 and the software SF2 when doing so is called as version Ver2.2. It is to be noted that the software SF1 in which the update UT-4 is executed is called as version Ver1.4, the software SF2 when doing so is called as version Ver2.3, and the software SF3 when doing so is called as version Ver3.1.

Thus, the update data created in the software-creating portion 11 is supplied to the receiver 20 by utilizing the broadcast signals as described above. In the receiver 20, the software in the memory 34 can be revised by using the received update data.

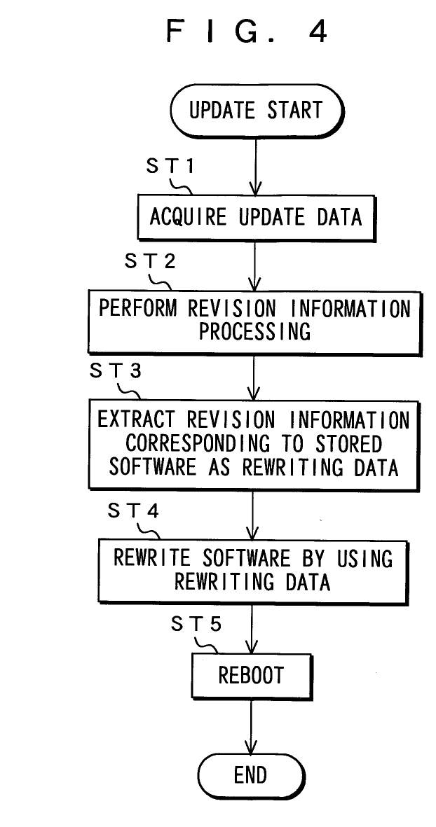

FIG. 4 is a flowchart showing update operations. At step ST1, update data is acquired and the process goes to step ST2 where revision processing is performed thereon so that the revision information relative to software that is different from the software stored in the memory 34 can be separated and maintained. When such the revision information has been already maintained, the maintained revision information is changed by using newly acquired revision information.

At step ST3, the revision information corresponding to the software stored in the memory 34 is extracted from the update data to set it as rewriting data and the process goes to step ST4. At step ST4, the software stored in the memory 34 is rewritten using the rewriting data that is the revision information extracted at step ST3.

For example, the update UT-3 is executed when the software SF2 of version Ver2.1 is stored in the memory 34, the receiver 20 performs processing for deletion of the files Fa and Fd and for change of the files Fb and Fc to Fb-3 and Fc-2, respectively, by the rewriting data extracted from the update data. In this time, a version of the software SF2 in the memory 34 becomes version Ver2.2.

At step ST5, since the software in the memory 34 has been revised, the receiver 20 reboots to execute the revised software. Thus, the update of the software stored in the memory 34 can be automatically executed.

Next, the following will describe a case where a user acquires version-up data and executes the version-up on the software stored in the memory 34.

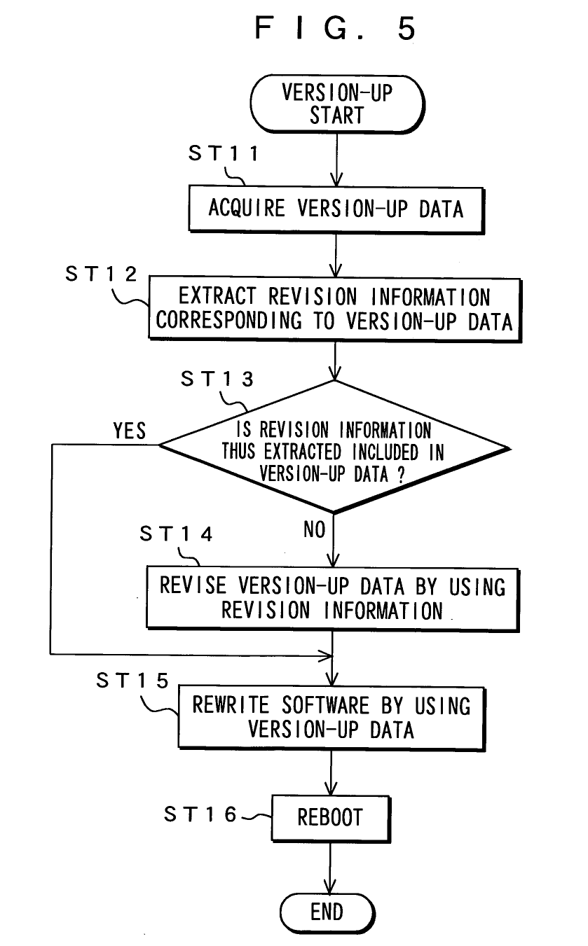

FIG. 5 is a flowchart showing version-up operations. At step ST11, version-up data is acquired and the process goes to step ST12 where revision information corresponding to the version-up data is extracted from the maintained revision information, and then, the process goes to step ST13.

At step ST13, it is determined whether contents of the revision information extracted at step ST12 are included in the version-up data. If the contents of the revision information are included therein, namely, the version-up data is the latest one, the process goes to step ST15. If the contents of the revision information are not included therein, namely, update is not executed on the version-up data, the process goes to step ST14.

At step ST14, the version-up data is revised by using extracted revision information to become the latest one, and the process then goes to step ST15. At step ST15, the software in the memory 34 is rewritten using the latest version-up data.

For example, as shown in FIGS. 3A through 3D, if the version-up is executed on the software in the memory 34 to produce the software SF3 before the update UT-4 is made, the software SF3 of version Ver3.0 includes revision contents by the update UT-3. This allows the process to go from step ST13 to step ST15 where the software in the memory 34 is rewritten to the software of version Ver3.0.

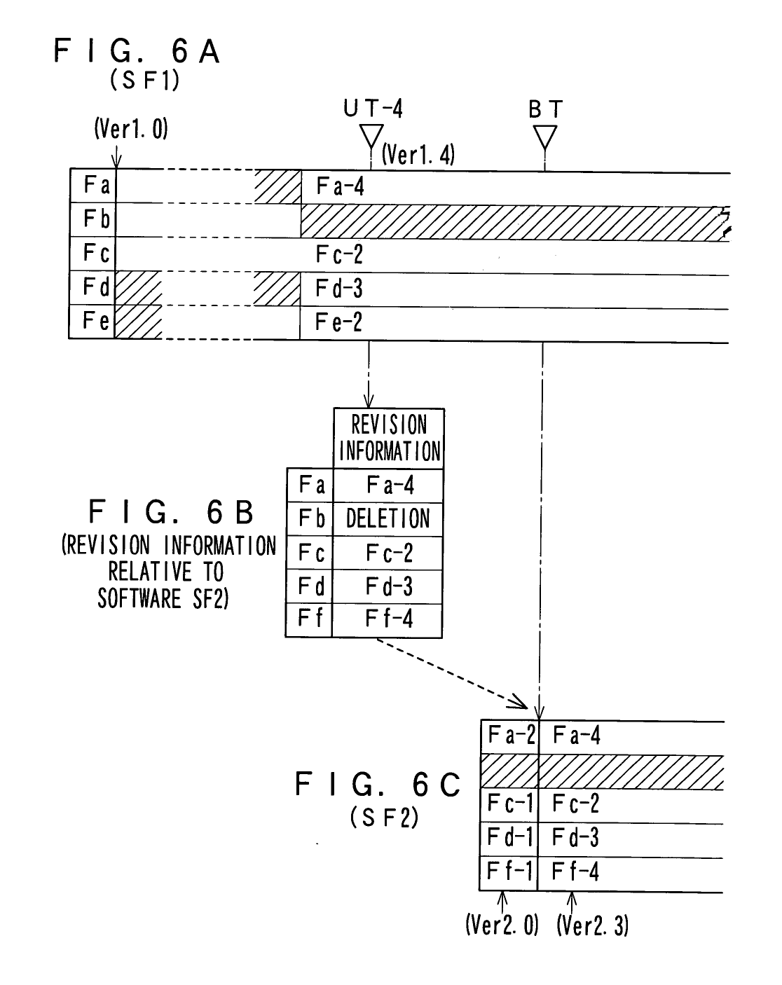

Further, as shown in FIGS. 6A through 6C, if a revision as the version-up BT is executed on the software in the memory 34 from the software SF1 shown in FIG. 6A to software SF2 shown in FIG. 6C after the update UT-4 is made when the distributed version-up data is the software SF2 of version Ver2.0, revision contents of the updates from UT-2 to UT-4 as shown in FIGS. 3A through 3D are not executed therein, so that the process goes to step ST14. At step ST14, the revision contents of the updates UT-2 to UT-4 are reflected to the software SF2 of version Ver2.0, which is version-up data. Since pieces of the revision information maintained in the receiver 20 is successively revised with newly acquired revision information, the revision information relative to the software SF2 when the update UT-4 is executed is shown in FIG. 6B. Namely, revision contents of the update UT-4 appear on the files Fa, Fb, Fd-Fg. Since file Fc is not revised at the update UT-4 , revision contents of the update UT-3 appear on the file. Thus, based on the revision information, file Fa in the software SF2 of version Ver2.0 is changed to Fa-4 , file Fb is deleted, file Fc is changed to Fc-2, file Fd is changed to Fd-3, and file Ff is changed to Ff-4. By the software SF2 revised on the basis of this revision information, the software in the memory 34 is rewritten to make it equal as the latest version Ver2.3. It is to be noted that although the software in the memory 34 is rewritten using the software SF2 of version Ver2.0 and then the software in the memory 34 can be revised on the basis of the revision information, number of times for rewriting it in the memory 34 can be decreased if the software revised on the basis of the revision information is written into the memory 34.

At step ST16, since the software in the memory 34 is revised, the receiver 20 reboots to execute the revised software.

If the version-up is executed using version-up data before update, the version-up data is revised to the latest one and written into the memory 34, so that the latest version-up may be made if no version-up is made in consideration of its order.

Although the update data have included revision information relative to multiple items of version-up data in the above embodiments, the version-up data may include revision information relative to other version-up data. For example, the software SF2 of version Ver2.3 is distributed as the version-up data and the revision information for revising the software SF3 from its version Ver3.0 to version Ver3.1 is included therein. In this case, even if using the software SF3 of version Ver3.0 as the version-up data, this revision information allows the software to be automatically rewritten to its latest version Ver3.1.

Distribution of the update data and the version-up data is not limited to a case where the above broadcast signal, network, recording medium and the like are used, and for example, the update data and the version-up data may be distributed using identical transmission path or identical kinds of the recording medium, for example. Of course, if an apparatus can use the software and rewrite it, it can be applied to not only receiving apparatus but also any electronic apparatus.

According to the invention, each of the multiple items of revision data to be distributed includes revision information relative to other software revision data after a period of time of each of their applications. Further, if any processing based on the maintained software is executed and the maintained software is rewritten by using the distributed software revision data when the revision information included in the software revision data is maintained and the revision information on the software revision data to be rewritten is maintained, the software including this revision information is rewritten.

Thus, even if the software revision data to be used for rewriting the software is revised, the software can be revised to the latest one since the software is rewritten reflecting the revision contents thereof in the software revision data.

### INDUSTRIAL APPLICABILITY

The invention is effective in a case where the software can be revised to its latest one and is preferable to a case where update and/or version-up are executed.

1. A software revision system comprising:
software-distributing means for distributing multiple items of software revision data; and
software-processing means for maintaining software and performing processing based on the maintained software as well as for rewriting the maintained software by using the software revision data that is distributed with the software-distributing means,
wherein the software-distributing means distributes the software revision data including revision information relative to other software revision data after a period of time of its application; and
wherein the software-processing means maintains the revision information included in the software revision data when rewriting the software by using the software revision data, and rewrites the software including the revision information if the revision information on the software revision data is maintained.

2. The software revision system according to claim 1, wherein the software-distributing means distributes update data that indicates a part to be revised of the software and version-up data that is new revised software, as the multiple items of software revision data, and allows the revision information of the version-up data after a period of time of its application to be included in the update data; and
wherein the software-processing means maintains the revision information included in the update data if rewriting the software by using the update data, and if rewriting the software by using the version-up data, rewrites the software including the revision information when the revision information relative to the version-up data is maintained.

3. The software revision system according to claim 1, wherein the software-distributing means distributes the multiple items of software revision data to the software-processing means via multiple paths.

4. The software revision system according to claim 1, wherein the software-distributing means distributes update data that indicates a part to be revised of the software and version-up data that is new revised software, as the multiple items of software revision data, and allows the revision information of the version-up data after a period of time of its application to be included in the update data, and distributes the update data including the revision information of the version-up data after a period of time of its application and the version-up data to the software-processing means via multiple paths.

5. A software distribution apparatus comprising:
software-creating means for creating multiple items of software revision data with each item of the software revision data including revision information relative to other software revision data after a period of time of its application; and
software-disseminating means for disseminating the software created in the software-creating means.

6. The software distribution apparatus according to claim 5 wherein the software-creating means distributes update data that indicates a part to be revised of the software and version-up data that is new revised software, as the multiple items of software revision data, the update data being distributed with it including the revision information of the version-up data after a period of time of its application.

7. The software distribution apparatus according to claim 5 wherein the software-disseminating means disseminates the multiple items of software revision data via multiple paths.

8. The software distribution apparatus according to claim 5 wherein the software-creating means distributes update data that indicates a part to be revised of the software and version-up data that is new revised software, as the multiple items of software revision data, the update data being distributed with it including the revision information of the version-up data after a period of time of its application; and wherein the software-disseminating means disseminates the update data including the revision information of the version-up data after a period of time of its application and the version-up data via multiple paths.

9. A software-processing apparatus operating by using software that is rewritably stored, comprising:
revision-information-processing means for, when software revision data includes revision information relative to other software revision data after a period of time of its application, separating and maintaining the revision information;
rewriting means for rewriting the stored software by using the software revision data; and
data-revising means for supplying to the rewriting means the software revision data including the revision information thereof when maintaining the revision information relative to the software revision data in the revision-information-processing means.

10. The software-processing apparatus according to claim 9, wherein, when the update data indicating a part to be revised of the software includes revision information of the version-up data that is new revised software after a period of time of its application, the revision-information-processing means separates and maintains the revision information;
wherein the data-revising means supplies to the rewriting means the version-up data including the revision information thereof when maintaining the revision information relative to the version-up data in the revision-information-processing means; and
wherein the rewriting means rewrites the software stored in the storage means by using any one of the update data and the version-up data including the revision information.

11. A software revision method comprising:
a software-distributing step of distributing multiple items of software revision data with each item of software revision data including revision information relative to other software revision data after a period of time of its application; and
a software-processing step of, when rewriting software by using the software revision data, maintaining the revision information if the revision information is included in the software revision data, and rewriting the software including the revision information if the revision information on the software revision data is maintained.
